(19) United States
(12) Patent Application Publication
(10) Pub. No.: US 2023/0007873 A1
(43) Pub. Date: Jan. 12, 2023

(54) Management Method and Apparatus for System Configuration Independent of Smart Contract for Blockchain

(71) Applicant: HANGZHOU RIVTOWER TECHNOLOGY CO., LTD, Hangzhou, Zhejiang (CN)

(72) Inventors: Xiaoliang WANG, Hangzhou, Zhejiang (CN); Zhiwei NING, Hangzhou, Zhejiang (CN)

(21) Appl. No.: 17/784,679

(22) PCT Filed: Dec. 15, 2020
(86) PCT No.: PCT/CN2020/136596

§ 371 Date: Jun. 13, 2022

(30) Foreign Application Priority Data
Apr. 1, 2020 (CN) 202010248712.0

(51) Int. Cl. H04L 9/32; H04L 9/00

(52) U.S. Cl. CPC H04L 9/32; H04L 9/50

(57) ABSTRACT

A management method and apparatus for a system configuration independent of a smart contract for a blockchain is provided. The method includes that: a blockchain node receives a new proposal, where the new proposal includes at least one transaction; the blockchain node determines whether a special transaction exists in the at least one transaction, where the special transaction is used for storing system configuration content without service logic; the blockchain node verifies the special transaction according to a preset verification rule to obtain a verification result in response to determining that the special transaction exists in the at least one transaction; and the blockchain node performs, in response to the verification result indicating that the special transaction passes verification, update management on a current system configuration according to the system configuration content.

### TECHNICAL FIELD

The present disclosure relates to the technical field of a blockchain, and in particular to a management method and apparatus for a system configuration independent of a smart contract for a blockchain.

### BACKGROUND

A blockchain, a cutting-edge technology of current society, is a decentralized and innovative solution employing the distributed ledger technology to solve a multi-party trust issue.

The blockchain requires some system configuration data, such as a consensus node account list and an admin account. Usually, a preset smart contract is used for managing system configurations, resulting in that the blockchain depends on the smart contract and a virtual machine executing the smart contract. For example, when the blockchain has to support various smart contract programming languages and virtual machines, a system contract has to be implemented repeatedly. For another example, operation of a consensus algorithm depends on the latest consensus node account list. The latest consensus node account list can be obtained after the virtual machine completes transactions in a previous block. Therefore, it is difficult to optimize asynchronous processing. It is also difficult to switch to consensus algorithms with uncertainty such as Proof Of Work (POW). When a chain is switched between different branches, it is necessary to wait for the virtual machine to be executed on a new chain and obtain the latest consensus node account list.

It can be seen that because management of the system configuration data depends on the smart contract, a consensus module requiring the configuration data depends on the smart contract, and implementation of the system configurations is inflexible.

### SUMMARY

At least some embodiments of the present disclosure provide a management method and apparatus for a system configuration independent of a smart contract for a blockchain, so as at least to remove dependence on the smart contract and improve flexibility of the system configuration.

In an embodiment of the present disclosure, a management method for a system configuration independent of a smart contract for a blockchain is provided. The method includes:

receiving, by a blockchain node, a new proposal, where the new proposal includes at least one transaction;

determining, by the blockchain node, whether a special transaction exists in the at least one transaction, where the special transaction is used for storing system configuration content without service logic;

in response to determining that the special transaction exists in the at least one transaction, verifying, by the blockchain node, the special transaction according to a preset verification rule to obtain a verification result; and

in response to the verification result indicating that the special transaction passes verification, performing, by the blockchain node, update management on a current system configuration according to the system configuration content.

In another embodiment of the present disclosure, a management method for a system configuration independent of a smart contract for a blockchain is further provided. The method includes:

constructing, by a management terminal, a special transaction according to a preset transaction format and system configuration content, where the special transaction is used for storing system configuration content without service logic; and

adding, by the management terminal, the special transaction to a new proposal and sending, by the management terminal, the new proposal to the blockchain.

In another embodiment of the present disclosure, a management apparatus for a system configuration independent of a smart contract for a blockchain is further provided. The apparatus includes:

a reception module configured to receive a new proposal, where the new proposal includes at least one transaction;

a determination module configured to determine whether a special transaction exists in the at least one transaction, where the special transaction is used for storing system configuration content without service logic;

a verification module configured to verify the special transaction according to a preset verification rule to obtain a verification result in response to determining that the special transaction exists in the at least one transaction; and

an update module configured to perform, in response to the verification result indicating that the special transaction passes verification, update management on a current system configuration according to the system configuration content.

In another embodiment of the present disclosure, a management apparatus for a system configuration independent of a smart contract for a blockchain is further provided. The apparatus includes:

a construction module configured to construct a special transaction according to a preset transaction format and system configuration content, where the special transaction is used for storing system configuration content without service logic; and

a sending module configured to add the special transaction to a new proposal and send the new proposal to the blockchain.

In another embodiment of the present disclosure, a management system for a system configuration independent of a smart contract for a blockchain is further provided. The system includes: a blockchain network composed of multiple blockchain nodes and a management terminal, where

the management terminal is configured to construct a special transaction according to a preset transaction format and system configuration content, where the special transaction is used for storing system configuration content without service logic; add the special transaction to a new proposal and send the new proposal to the blockchain;

the blockchain node is configured to receive the new proposal, where the new proposal includes at least one transaction; determine whether the special transaction exists in the at least one transaction, where the special transaction is used for storing the system configuration content without the service logic; verify the special transaction according to a preset verification rule to obtain a verification result in response to determining that the special transaction exists in the at least one transaction; and in response to the verification result indicating that the special transaction passes verification, perform update management on a current system configuration according to the system configuration content.

In another embodiment of the present disclosure, an electronic device is further provided. The electronic device includes:

a processor; and

a memory configured to store at least one computer executable instruction, where the at least one computer executable instruction is used for enabling the processor to execute the method mentioned above when being executed.

In another embodiment of the present disclosure, a computer-readable storage medium storing at least one program is further provided, where when being executed by an electronic device including multiple applications, at least one program enables the electronic device to execute the method mentioned above.

It may be seen from the technical solutions provided by at least some embodiments of the present disclosure that the system configuration content without the service logic is put into the special transaction, and update management on a blockchain system configuration is achieved through transaction processing, such that the problem that various system configurations depend on smart contracts due to updates on the smart contracts is solved, and particularly, dependence of system configurations required by consensus on smart contracts may be avoided, thereby effectively decoupling the consensus from the smart contracts.

### BRIEF DESCRIPTION OF THE DRAWINGS

To more clearly describe technical solutions in at least one embodiment of the present disclosure or in the related art, a brief introduction to the accompanying drawings required for the description of at least one embodiments or the related art will be provided below. Obviously, the accompanying drawings in the following description are some embodiments of the present disclosure. Those of ordinary skill in the art would also derive other accompanying drawings from these accompanying drawings without making inventive efforts.

FIG. 1 is a flow chart of a management method for a system configuration independent of a smart contract for a blockchain according to an embodiment of the present disclosure.

FIG. 2 is a flow chart of another management method for a system configuration independent of a smart contract for a blockchain according to an embodiment of the present disclosure.

FIG. 3 is a flow chart of management of a system configuration independent of a smart contract for a blockchain according to an embodiment of the present disclosure.

FIG. 4 is a structural schematic diagram of a management apparatus for a system configuration independent of a smart contract for a blockchain according to an embodiment of the present disclosure.

FIG. 5 is a structural schematic diagram of another management apparatus for a system configuration independent of a smart contract for a blockchain according to an embodiment of the present disclosure.

FIG. 6 is a structural schematic diagram of an electronic device according to an embodiment of the present disclosure.

### DETAILED DESCRIPTION

To enable those skilled in the art to better understand the technical solutions of the present disclosure, the technical solutions in at least one embodiment of the present disclosure will be clearly and completely described in conjunction with the accompanying drawings in at least one embodiment of the present disclosure, and it is obvious that at least one embodiments described are some embodiments of the present disclosure, not all embodiments. Based on at least one embodiment of the present disclosure, all the other embodiments obtained by those of ordinary skill in the art without inventive effort are within the protection scope of the present disclosure.

### Embodiment One

FIG. 1 is a flow chart of a management method for a system configuration independent of a smart contract for a blockchain provided by an embodiment of the present disclosure. It should be understood that this method is applied to a blockchain network, and an executed object may be a management apparatus for implementing a system configuration without depending on a smart contract for a blockchain. The management method may include the following steps.

In step 102, a blockchain node receives a new proposal and the new proposal includes at least one transaction.

In step 104, the blockchain node determines whether a special transaction exists in the at least one transaction, where the special transaction is used for storing system configuration content without service logic.

In response to the special transaction existing in the at least one transaction, step 106 is executed; and otherwise, a transaction is processed according to a normal operation.

It should be understood that the new proposal may include multiple transactions, and therefore it is necessary to scan the multiple transactions one by one to identify whether the special transaction exists in the at least one transaction.

In an optional embodiment, the special transaction includes a configuration field for indicating that the special transaction is used for storing the system configuration content, such that whether the special transaction exists in the at least one transaction may be determined as follows. It is determined whether the special transaction carries the configuration field. Specifically, whether the special transaction carrying the configuration field is scanned and identified may be determined by sequentially scanning the at least one transaction included in the new proposal.

In an embodiment of the present disclosure, a transaction format of the special transaction may be predefined by adding the configuration field. Specifically, a field in a transaction structure may be defined as the configuration field, and different parameter values of the configuration field may indicate different types of system configurations. For example, a “to” field in the transaction structure is set as the configuration field. When a value of the “to” field is identified to be 0x1, this transaction is the special transaction. Furthermore, different configuration types may further be indicated according to different parameter values of the configuration field. For example, the value of the “to” field in the transaction structure is set as 0x1, which indicates that this transaction is a special transaction for modifying a consensus node account list; and the value of the “to” field in the transaction structure is set as 0x2, which indicates that this transaction is a special transaction for modifying system configurations such as an administrator account.

Actually, at least one defined field may be flexibly selected as the configuration field, or at least one newly added field may further selected as the configuration field. The configuration field may be a nonce field, a quota field, or a value field in a specific case (there is no token in a certain mode, and the field is vacant and may be used as a configuration field).

It should be understood that the system configuration content without the service logic refers to no service logic existing in a process of configuration modification management, and therefore this system configuration may be carried and dynamically configured in the transaction instead of in the smart contract.

In step 106, the blockchain node verifies the special transaction according to a preset verification rule.

In an optional embodiment of the present disclosure, the system configuration content includes first configuration data and second configuration data. The first configuration data is configuration data used before performing update management on the current system configuration. The second configuration data is configuration data used after performing update management on the current system configuration. The special transaction carries an identifier of a transaction initiator. An operation that the blockchain node verifies the special transaction according to the preset verification rule may specifically include the following step. The blockchain node performs a format verification on the special transaction according to a preset transaction format. The blockchain node performs an identity verification on the transaction initiator of the special transaction according to a pre-stored administrator identifier. And the blockchain node performs a validity verification on the first configuration data according to currently used configuration data.

An operation that the blockchain node performs the format verification on the special transaction according to the preset transaction format may specifically include the following steps. The blockchain node performs the format verification on the special transaction according to a predefined transaction format of the special transaction, so as to ensure a correct format. The identity verification is performed on the transaction initiator of the special transaction according to the pre-stored administrator identifier (for example, an administrator list), so as to determine whether the special transaction is initiated by an administrator account. Actually, a signature of the special transaction may also be verified according to a public key of the transaction initiator, so as to determine whether the special transaction is initiated by the administrator account. In addition, considering that multiple special transactions may be received at the same time, system configurations of all the special transactions are different. Therefore, in an optional embodiment of the present disclosure, the first configuration data may be compared with the currently used configuration data to obtain a comparison result, so as to verify whether the special transaction is valid to obtain a comparison result. When the comparison result shows the first configuration data is consistent with the currently used configuration data, it indicates that the special transaction is valid in a system configuration management process. When the comparison result shows the first configuration data is inconsistent with the currently used configuration data, it indicates that the special transaction is invalid in the system configuration management process.

In step 108, in response to the verification result indicating that the special transaction passes verification, the blockchain node performs update management on a current system configuration according to the system configuration content in the special transaction.

It should be understood that in an optional embodiment of the present disclosure, after all of the format verification, the identity verification and the validity verification are passed, a verification of the special transaction may be considered to be passed. Furthermore, after all the verifications are passed, the blockchain node performs configuration update management on the current system configuration according to the second configuration data.

Optionally, in an optional embodiment of the present disclosure, the system configuration content without the service logic includes at least one of the following: a consensus node account list and an administrator account list.

With the technical solution, the system configuration content without the service logic is put into the special transaction, and update management on a blockchain system configuration is achieved through transaction processing, such that the problem that various system configurations depend on smart contracts due to updates on the smart contracts is solved, and particularly, dependence of system configurations required by consensus on smart contracts may be avoided, thereby effectively decoupling the consensus from the smart contracts.

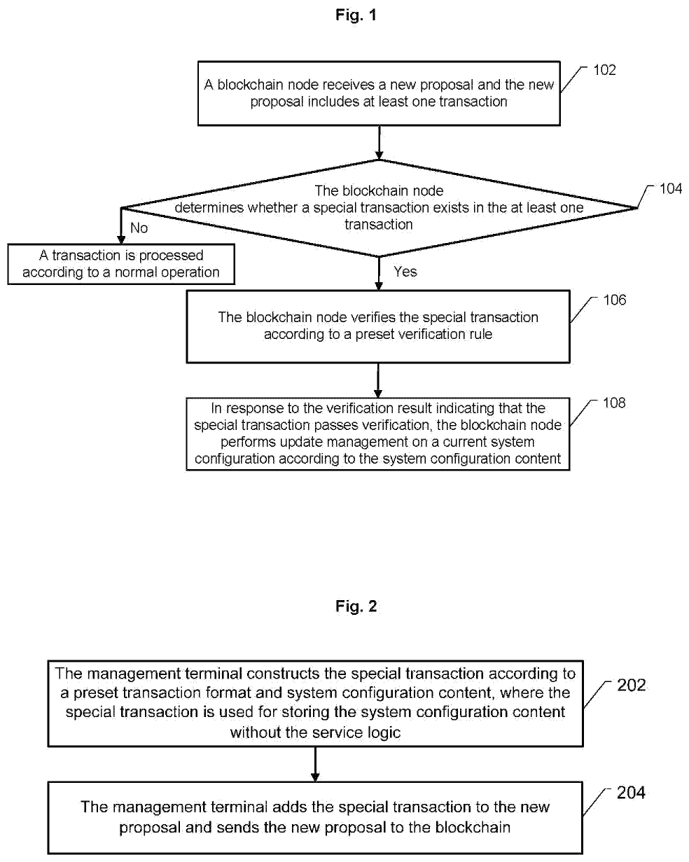

FIG. 2 is a flow chart of another management method for a system configuration independent of a smart contract for a blockchain according to an embodiment of the present disclosure. An executed object of the method may be a management terminal operated by an administrator. The method includes the following steps.

In step 202, the management terminal constructs the special transaction according to a preset transaction format and system configuration content, where the special transaction is used for storing the system configuration content without the service logic.

It should be understood that the preset transaction format may refer to the transaction format described in the solution of FIG. 1, and a specific construction mode may be achieved according to an existing transaction construction mode in the blockchain, which will not be repeated herein.

The related description of the system configuration content without the service logic is consistent with the description of the solution of FIG. 1.

In step 204, the management terminal adds the special transaction to the new proposal and sends the new proposal to the blockchain.

Actually, before the special transaction is sent, the management terminal may sign the special transaction with a private key of a locally generated public-private key pair, and then add the special transaction to the new proposal and send the new proposal to the blockchain.

With the technical solution, the system configuration content without the service logic is put into the special transaction, and the update management on the blockchain system configuration is achieved through transaction processing, such that the problem that various system configurations depend on smart contracts due to updates on the smart contracts is solved, and particularly, dependence of system configurations required by consensus on smart contracts may be avoided, thereby effectively decoupling the consensus from the smart contracts.

A management solution of the system configuration is described in detail with the following specific examples.

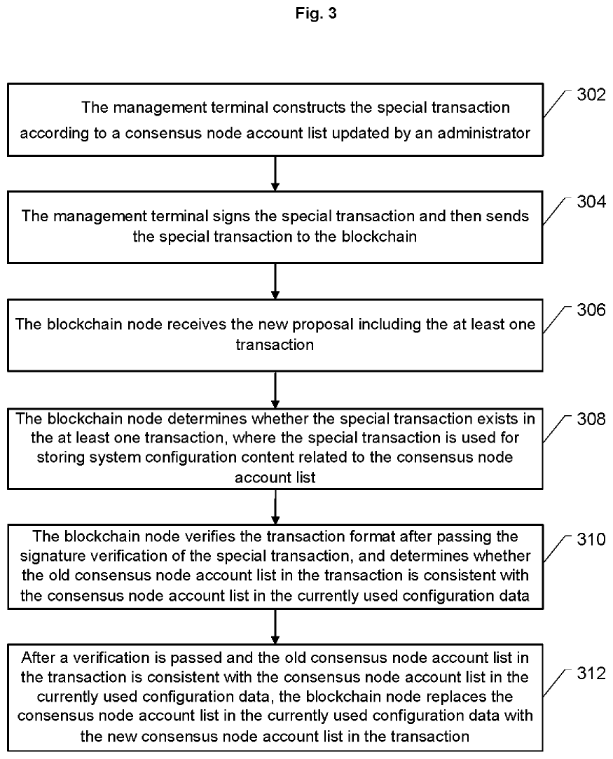

It should be understood that management of different system configurations may be processed at different stages, and the system configuration content is different while specific implementation of management of the system configurations is similar every time. Modifying a consensus node list is taken as an example. It is assumed that the transaction format of the special transaction is predefined, and updating a management consensus node account list is taken as an example. As shown in FIG. 3, the method includes the following steps.

In step 302, the management terminal constructs the special transaction according to a updated consensus node account list confirmed by an administrator.

Specifically, the administrator enquires a current consensus node account list in a blockchain, updates the consensus node account list as required, and then the management terminal constructs the special transaction according to the preset transaction format. The configuration field is the “to” field, and a parameter value of the “to” field is 0x1. Specifically, the system configuration content may at least include: new and old consensus node account lists, the number of new consensus node accounts, and the number of old consensus node accounts. An internal data structure may be as follows.

One byte indicates the number of consensus node accounts in the old consensus node account list (namely currently used consensus node account list), which is followed by the old consensus node account list.

One byte indicates the number of consensus node accounts in the new consensus node account list, which is followed by the new consensus node account list.

In step 304, the management terminal signs the special transaction and then sends the special transaction to the blockchain.

It should be understood that in order to ensure that it may be verified later that the special transaction is sent by the administrator, the special transaction may be signed before being sent. Specifically, the management terminal may sign the special transaction with the private key of the locally generated public-private key pair, and then send the signed special transaction to the blockchain.

In step 306: the blockchain node receives the new proposal including the at least one transaction.

In step 308: the blockchain node determines whether the special transaction exists in the at least one transaction, where the special transaction is used for storing system configuration content related to the consensus node account list.

It is determined whether the “to” field exists in the transaction and the parameter value of the “to” field is 0x1. When the “to” field exists in the transaction and the parameter value of the “to” field is 0x1, the special transaction is determined, and the special transaction is processed according to operations of step 310; and otherwise, execution is performed in a conventional transaction processing mode.

In step 310: the blockchain node verifies the transaction format after passing the signature verification of the special transaction, and determines whether the old consensus node account list in the transaction is consistent with the consensus node account list in the currently used configuration data.

In step 312: after a verification is passed and the old consensus node account list in the transaction is consistent with the consensus node account list in the currently used configuration data, the blockchain node replaces the consensus node account list in the currently used configuration data with the new consensus node account list in the transaction.

Therefore, system configuration data is put into the transaction so as to achieve a configuration update, such that the problem that various system configurations depend on smart contracts due to updates on the smart contracts is solved, and particularly, dependence of system configurations required by consensus on smart contracts may be avoided, thereby effectively decoupling the consensus from the smart contracts.

### Embodiment Two

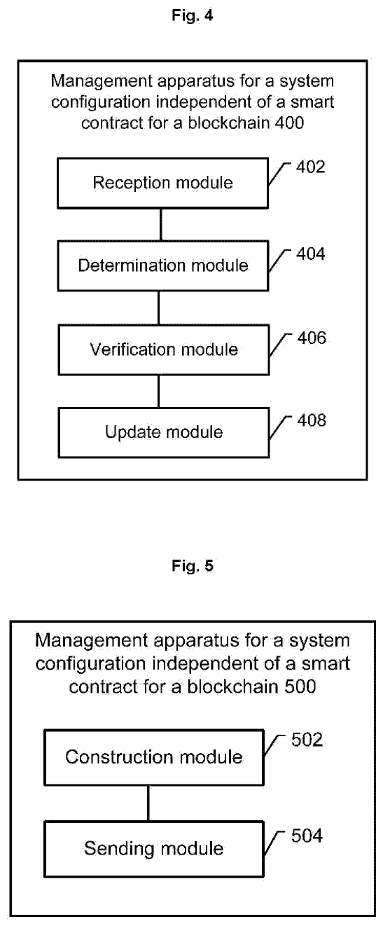

FIG. 4 shows a management apparatus for a system configuration independent of a smart contract for a blockchain provided by an embodiment of the present disclosure. The management apparatus 400 may specifically be a blockchain node, and the device 400 may include:

a reception module 402 configured to receive a new proposal and the new proposal includes at least one transaction;

a determination module 404 configured to determine whether a special transaction exists in the at least one transaction included in the new proposal, where the special transaction is used for storing system configuration content without service logic;

a verification module 406 configured to verify the special transaction according to a preset verification rule to obtain a verification result in response to determining that the special transaction exists in the at least one transaction; and

an update module 408 configured to perform, in response to the verification result indicating that the special transaction passes verification, update management on a current system configuration according to the system configuration content in the special transaction.

Optionally, as an embodiment, the special transaction includes a configuration field for indicating that the special transaction is used for storing the system configuration content without service logic; and

the determination module is configured to: sequentially scan the at least one transaction; and determine whether a special transaction carrying the configuration field is scanned and identified.

In a specific implementation of an embodiment of the present disclosure, the system configuration content includes first configuration data and second configuration data, where the first configuration data is configuration data used before performing update management on the current system configuration, and the second configuration data is configuration data used after performing update management on the current system configuration; the special transaction carries an identifier of a transaction initiator;

the verification module is configured to perform a format verification on the special transaction according to a preset transaction format; perform an identity verification on the transaction initiator of the special transaction according to a pre-stored administrator identifier; and perform a validity verification on the first configuration data according to currently used configuration data; and

the update module is configured to perform, in response to the verification result indicating that the special transaction passes all of the format verification, the identity verification and the validity verification, configuration update management on the current system configuration according to the second configuration data.

In another specific implementation of an embodiment of the present disclosure, the system configuration content without the service logic includes at least one of the following: a consensus node account list and an administrator account list.

FIG. 5 shows another management apparatus for a system configuration independent of a smart contract for a blockchain according to an embodiment of the present disclosure. The management apparatus 500 may be a management terminal, and the device 500 may include:

a construction module 502 configured to construct the special transaction according to the preset transaction format and system configuration content, where the special transaction is used for storing the system configuration content without the service logic; and

a sending module 504 configured to add the special transaction to the new proposal and send the new proposal to the blockchain.

With the technical solution, the system configuration content without the service logic is put into the special transaction, and update management on a blockchain system configuration is achieved through transaction processing, such that the problem that various system configurations depend on smart contracts due to updates on the smart contracts is solved, and particularly, dependence of system configurations required by consensus on smart contracts may be avoided, thereby effectively decoupling the consensus from the smart contracts.

### Embodiment Three

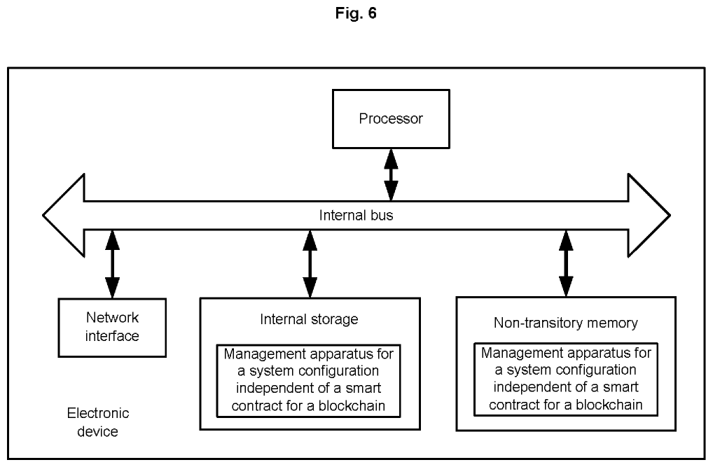

FIG. 6 is a structural schematic diagram of an electronic device according to an embodiment of the present disclosure. As shown in FIG. 6, at a hardware level, the electronic device includes a processor, and optionally may include an internal bus, a network interface and a memory. The memory may include an internal storage, such as a random-access memory (RAM), and may also include a non-transitory memory, such as at least one disk memory. Of course, the electronic device may also include hardware required by other services.

The processor, the network interface and the memory may be connected with each other by means of the internal bus, and the internal bus may be an industry standard architecture (ISA) bus, a peripheral component interconnect (PCI) bus, an extended industry standard architecture (EISA) bus, etc. The bus may be classified into an address bus, a data bus, a control bus, etc. For convenience of denotation, one double-sided arrow is used in FIG. 6 for denotation, which does not indicate that there is one bus or one type of bus.

The memory is configured to store a program. Specifically, the program may include a program code that includes at least one computer operation instruction. The memory may include the internal storage and the non-transitory memory, and supplies the at least one computer operation instruction and data to the processor.

The processor reads a corresponding computer program from the non-transitory memory and runs the computer program in the internal storage, and the management apparatus for a system configuration independent of a smart contract for a blockchain is formed at a logical level. The processor executes a program stored in the memory and is configured to execute operations of:

receiving a new proposal, where the new proposal includes at least one transaction;

determining whether a special transaction exists in the at least one transaction, where the special transaction is used for storing system configuration content without service logic;

in response to determining that the special transaction exists in the at least one transaction, verifying the special transaction according to a preset verification rule to obtain a verification result; and

in response to the verification result indicating that the special transaction passes verification, performing update management on a current system configuration according to the system configuration content;

alternatively,

constructing a special transaction according to a preset transaction format and system configuration content, where the special transaction is used for storing system configuration content without service logic; and

adding the special transaction to a new proposal and sending the new proposal to the blockchain.

The method executed by the apparatus disclosed in the embodiments of the present disclosure shown in FIGS. 1 and 2 may be used in or achieved by the processor. The processor may be an integrated circuit chip with signal processing capability. In an implementation process, each step of the method may be completed by a hardware integrated logic circuit in the processor or an instruction in the form of software. The processor may be a general-purpose processor, such as a central processing unit (CPU) or a network processor (NP); or may further be a digital signal processor (DSP), an application specific integrated circuit (ASIC), a field-programmable gate array (FPGA) or other programmable logic devices, a discrete gate or transistor logic device, or a discrete hardware component. The methods, steps and logic diagrams disclosed in at least one embodiment of the present disclosure may be implemented or executed. The general-purpose processor may be a microprocessor, or the processor may further be any conventional processor, etc. The steps of the method disclosed in coordination with at least one embodiment of the present disclosure may be directly implemented by a hardware decoding processor, or by a combination of hardware and software modules in a decoding processor. The software module may be located in a RAM, a flash memory, a read-only memory, a programmable read-only memory or an electrically erasable programmable memory, a register and other mature storage media in the field. The storage medium is located in the memory, and the processor reads information in the memory and completes the steps of the method in combination with hardware.

The electronic device may also execute the methods shown in FIGS. 1 and 2, and achieve functions of corresponding devices in the embodiments shown in FIGS. 1 and 2, which will not be repeated herein.

Of course, except a software implementation, the electronic device of the embodiment of the present disclosure is not exclusive of other implementations, such as an implementation of a logic device or a combination of software and hardware, that is to say, an executed object of the following processing flow is not limited to each logic unit, and may also be hardware or a logic device.

With the technical solution, the system configuration content without the service logic is put into the special transaction, and update management on a blockchain system configuration is achieved through transaction processing, such that the problem that various system configurations depend on smart contracts due to updates on the smart contracts is solved, and particularly, dependence of system configurations required by consensus on smart contracts may be avoided, thereby effectively decoupling the consensus from the smart contracts.

### Embodiment Four

An embodiment of the present disclosure further provides a computer-readable storage medium that stores at least one program, where the at least one program include at least one instruction, and when being executed by a portable electronic device including multiple applications, the instruction enables the portable electronic device to execute the methods of the embodiments shown in FIGS. 1 and 2 and to be configured to execute operations of:

receiving a new proposal, where the new proposal includes at least one transaction;

determining whether a special transaction exists in the at least one transaction, where the special transaction is used for storing system configuration content without service logic;

in response to determining that the special transaction exists in the at least one transaction, verifying the special transaction according to a preset verification rule to obtain a verification result; and

in response to the verification result indicating that the special transaction passes verification, performing update management on a current system configuration according to the system configuration content;

alternatively,

constructing a special transaction according to a preset transaction format and system configuration content, where the special transaction is used for storing system configuration content without service logic; and

adding the special transaction to a new proposal and sending the new proposal to the blockchain.

With the technical solution, the system configuration content without the service logic is put into the special transaction, and update management on a blockchain system configuration is achieved through transaction processing, such that the problem that various system configurations depend on smart contracts due to updates on the smart contracts is solved, and particularly, dependence of system configurations required by consensus on smart contracts may be avoided, thereby effectively decoupling the consensus from the smart contracts.

In conclusion, the above descriptions are exemplary embodiments of the present disclosure and are not used to limit the protection scope of the present disclosure. Any modifications, equivalent substitutions, improvements, etc. within the spirit and principles of the present disclosure are intended to fall within the scope of protection of the present disclosure.

The systems, devices, modules or units described in at least one embodiment described above may be specifically implemented by computer chips or entities, or by products with certain functions. Atypical implementation apparatus is a computer. Specifically, the computer may be, for example, a personal computer, a laptop computer, a cellular phone, a camera phone, a smart phone, a personal digital assistant, a media player, a navigation apparatus, an email apparatus, a game console, a tablet computer, a wearable apparatus, or a combination of any of the apparatuses.

A computer-readable medium may be permanent or non-permanent, and removable or non-removable, and may store information through any method or technique. The information may be computer-readable instructions, data structures, program modules, or other data. Examples of a computer storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical memories, a cassette tape, tape or disk memories or other magnetic storage apparatuses, or any other non-transmission media that may be used to store information capable of being accessed by a computing apparatus. According to definitions herein, the computer-readable medium does not include transitory media, such as modulated data signals and carrier waves.

It should be noted that, terms “include”, “contain”, or any other variations thereof are intended to cover non-exclusive inclusions, such that processes, methods, commodities, or apparatuses including a series of elements not only include the elements, but also include other elements that are not explicitly listed, or also include inherent elements of the processes, methods, commodities, or apparatuses. Without more restrictions, the elements defined by the sentence “includes a . . . ” do not exclude the existence of other identical elements in the processes, methods, commodities, or apparatuses including the elements.

The embodiments in the present disclosure are all described in a progressive manner, mutual reference may be made to the same or similar parts of the embodiments, and each embodiment focuses on description of differences from other embodiments. In particular, the system embodiment is basically similar to the method embodiment and therefore is described simply, and for a related part, reference may be made to the part of the description of the method embodiment.

The specific embodiments of the present disclosure are described above. Other embodiments fall within the scope of the appended claims. In some cases, actions or steps recited in the claims may be executed in a different order from those in the embodiments and still achieve a desired result. In addition, the processes depicted in the drawings do not necessarily require a specific sequence or continuous sequence shown to achieve the desired result. In some embodiments, multitasking and parallel processing are also possible or may be advantageous.

What is claimed is:

1. A management method for a system configuration independent of a smart contract for a blockchain, comprising:
receiving, by a blockchain node, a new proposal, wherein the new proposal comprises at least one transaction;
determining, by the blockchain node, whether a special transaction exists in the at least one transaction, wherein the special transaction is used for storing system configuration content without service logic;
in response to determining that the special transaction exists in the at least one transaction, verifying, by the blockchain node, the special transaction according to a preset verification rule to obtain a verification result; and
in response to the verification result indicating that the special transaction passes verification, performing, by the blockchain node, update management on a current system configuration according to the system configuration content.

2. The management method for the system configuration independent of the smart contract for the blockchain as claimed in claim 1, wherein the special transaction comprises a configuration field for indicating that the special transaction is used for storing the system configuration content without service logic; and
determining whether the special transaction exists in the at least one transaction comprises:
sequentially scanning the at least one transaction; and
determining whether a special transaction carrying the configuration field is scanned and identified.

3. The management method for the system configuration independent of the smart contract for the blockchain as claimed in claim 1, wherein the system configuration content comprises first configuration data and second configuration data, wherein the first configuration data is configuration data used before performing update management on the current system configuration, and the second configuration data is configuration data used after performing update management on the current system configuration; the special transaction carries an identifier of a transaction initiator;
verifying the special transaction according to the preset verification rule comprises:
performing a format verification on the special transaction according to a preset transaction format;
performing an identity verification on the transaction initiator of the special transaction according to a pre-stored administrator identifier; and
performing a validity verification on the first configuration data according to currently used configuration data; and
in response to the verification result indicating that the special transaction passes verification, performing the update management on the current system configuration according to the system configuration content in the special transaction specifically comprises:
in response to the verification result indicating that the special transaction passes all of the format verification, the identity verification and the validity verification, performing configuration update management on the current system configuration according to the second configuration data.

4. The management method for the system configuration independent of the smart contract for the blockchain as claimed in claim 3, wherein the system configuration content without service logic comprises at least one of the following:
a consensus node account list and an administrator account list.

5. (canceled)

6. A management apparatus for a system configuration independent of a smart contract for a blockchain, comprising:
a reception module configured to receive a new proposal, wherein the new proposal comprises at least one transaction;
a determination module configured to determine whether a special transaction exists in the at least one transaction comprised in the new proposal, wherein the special transaction is used for storing system configuration content without service logic;
a verification module configured to verify the special transaction according to a preset verification rule to obtain a verification result in response to determining that the special transaction exists in the at least one transaction; and
an update module configured to perform, in response to the verification result indicating that the special transaction passes verification, update management on a current system configuration according to the system configuration content.

7. The management apparatus for the system configuration independent of the smart contract for the blockchain as claimed in claim 6, wherein the special transaction comprises a configuration field for indicating that the special transaction is used for storing the system configuration content without service logic; and
the determination module is configured to:
sequentially scan the at least one transaction; and
determine whether a special transaction carrying the configuration field is scanned and identified.

8. The management apparatus for the system configuration independent of the smart contract for the blockchain as claimed in claim 6, wherein the system configuration content comprises first configuration data and second configuration data, wherein the first configuration data is configuration data used before performing update management on the current system configuration, and the second configuration data is configuration data used after performing update management on the current system configuration;
the special transaction carries an identifier of a transaction initiator;
the verification module is configured to:
perform a format verification on the special transaction according to a preset transaction format;
perform an identity verification on the transaction initiator of the special transaction according to a pre-stored administrator identifier; and
perform a validity verification on the first configuration data according to currently used configuration data; and
the update module is configured to:
perform, in response to the verification result indicating that the special transaction passes all of the format verification, the identity verification and the validity verification, configuration update management on the current system configuration according to the second configuration data.

9. The management apparatus for the system configuration independent of the smart contract for the blockchain as claimed in claim 8, wherein the system configuration content without service logic comprises at least one of the following:
a consensus node account list and an administrator account list.

10. (canceled)

11. A management system for a system configuration independent of a smart contract for a blockchain, comprising: a blockchain node and a management terminal, wherein
the management terminal is configured to construct a special transaction according to a preset transaction format and system configuration content, wherein the special transaction is used for storing system configuration content without service logic; add the special transaction to a new proposal and send the new proposal to the blockchain;
the blockchain node is configured to receive the new proposal, wherein the new proposal comprises at least one transaction; determine whether the special transaction exists in the at least one transaction, wherein the special transaction is used for storing the system configuration content without the service logic; verify the special transaction according to a preset verification rule to obtain a verification result in response to determining that the special transaction exists in the at least one transaction; and in response to the verification result indicating that the special transaction passes verification, perform update management on a current system configuration according to the system configuration content.

12. An electronic device, comprising:
a processor; and
a memory configured to store at least one computer executable instruction, wherein the at least one computer executable instruction is used for enabling the processor to execute the method as claimed in claim 1 when being executed.

13. A non-transitory computer-readable storage medium, storing at least one program, wherein when being executed by an electronic device comprising a plurality of applications, the at least one program enables the electronic device to execute the method as claimed in claim 1.

14. The management method for the system configuration independent of the smart contract for the blockchain as claimed in claim 2, wherein the configuration field is used for predefining a transaction format of the special transaction.

15. The management method for the system configuration independent of the smart contract for the blockchain as claimed in claim 2, wherein different parameter values of the configuration field are used for indicating different types of system configurations.

16. The management method for the system configuration independent of the smart contract for the blockchain as claimed in claim 2, wherein different parameter values of the configuration field are used for indicating different types of system configurations of special transactions.

17. The management method for the system configuration independent of the smart contract for the blockchain as claimed in claim 16, wherein a first value of the configuration field is used for indicating a special transaction for modifying a consensus node account list.

18. The management method for the system configuration independent of the smart contract for the blockchain as claimed in claim 16, wherein a second value of the configuration field is used for indicating a special transaction for modifying an administrator account.

19. The management method for the system configuration independent of the smart contract for the blockchain as claimed in claim 2, wherein at least one defined field is selected as the configuration field, or at least one newly added field is selected as the configuration field.

20. The management method for the system configuration independent of the smart contract for the blockchain as claimed in claim 1, wherein the system configuration content without the service logic refers to no service logic existing in a process of configuration modification management.
